(19) United States
(12) Patent Application Publication
(10) Pub. No.: US 2026/0284906 A1
(43) Pub. Date: Sep. 24, 2026

(54) GRIPPER END CAP AND GRIPPER FOR LAUNDRY ITEMS, HAVING TWO GRIPPER END CAPS

(71) Applicant: HERBERT KANNEGIESSER GMBH, Vlotho (DE)

(72) Inventors: Eduard REGIER, Leopoldshöhe (DE); Daniel GRETSCHMANN, Bad Salzuflen (DE)

(73) Assignee: HERBERT KANNEGIESSER GMBH, Vlotho (DE)

(21) Appl. No.: 19/569,348

(22) Filed: Mar. 17, 2026

(30) Foreign Application Priority Data
Mar. 18, 2025 (DE) 10 2025 110 427.1

(51) Int. Cl. B25J 15/00; B25J 15/04; D06F 95/00

(52) U.S. Cl. CPC B25J 15/0033; B25J 15/045; D06F 95/00

(57) ABSTRACT

A gripper for laundry items, and gripper end caps for grippers, which make it possible to achieve a gentle and cost-effective handling of the laundry items. This is achieved by the fact that grippers have gripping elements or gripping fingers for gripping laundry items. By pivoting these gripping fingers, the laundry items are clamped and can then be moved. Gripper end caps are arranged on these gripping fingers. The gripper end caps consist essentially of a body having a wave-like contour which extends at least partly around the body. By pivoting the gripping fingers, two gripper end caps are moved toward one another and a laundry item is clamped between them.

The invention relates to a gripper end cap for a gripper for gripping a laundry item, as claimed in claim 1. Furthermore, the invention relates to a gripper for laundry items, as claimed in claim 10.

Grippers of the type described are used in laundries, for example when gripping laundry items for the purpose of feeding them to further laundry treatment devices, such as for example transport systems, storage and sorting lines and the like, or when separating individual laundry items from a collection of a plurality of laundry items.

Known grippers are arranged movably on a robot arm and have, for example, two plate-like or pincer-like gripping elements that are movable relative to one another in order to clamp and move laundry items.

To make the use of grippers cost-effective, it is essential that the individual laundry items are gripped reliably and, above all, quickly; equally, however, gentle gripping is also necessary to protect the laundry from a loss of quality. In particular in the case of fast movements, there is the risk that laundry items gripped by the gripper slip out of the gripper. In the case of fast movements of the laundry items hanging from the gripper, the area where the laundry is being gripped is additionally affected by not only the dead weight, but also, due to the high acceleration, other pseudo forces that can have a negative effect on the condition of the individual laundry items. When separating individual laundry items from a pile of laundry consisting of intertwined laundry items, additional loads arise that must be absorbed by the gripper. If these loads are too high, it is important to avoid damaging the laundry items.

The problem addressed by the invention is to provide a gripper for laundry items, and gripper end caps for grippers, which make it possible to achieve a gentle but at the same time cost-effective handling of the laundry items.

To solve this problem, the gripper end cap according to the invention comprises the features of claim 1. For the purpose of gripping laundry items, in particular individual laundry items, grippers have gripping elements or gripping fingers. By pivoting these gripping fingers, the laundry items are clamped and can then be moved. The gripper end caps according to the invention are arranged on these gripping fingers. The gripper end caps for a gripper are used for gripping laundry items, preferably individual laundry items. These gripper end caps consist essentially of a body having a wave-like contour which extends at least partly around the body. By pivoting the gripping fingers, two gripper end caps are moved toward one another and -if there is a laundry item between the gripper fingers-a laundry item is clamped between them. Due to the groove-like contour, the laundry item is gripped securely, or reliably, specifically without damaging the laundry item due to sharp edges or the like. This allows both gentle but above all also cost-effective handling of the laundry items.

Preferably, it may also be provided that the body has a rectangular, polygonal, rounded, oval or elliptical base area and/or a rectangular, polygonal, rounded, oval or elliptical cross section. Due to this substantially rounded shape of the gripper end cap, it has no sharp edges at all that could damage the laundry items. In addition, this choice of shape prevents any laundry items from becoming stuck behind an edge and thus hindering the further handling of laundry items.

In particular, it may be provided that the wave-like contour extends at least partly around a lateral surface of the body, the contour being formed from semicircles and/or partial circles pointing away from the body and protruding into the body. In particular in cross section, the contour assumes the shape of semicircles and/or partial circles. This wave-like transfer between waves and troughs forms a particularly preferred continuous lateral surface, to which the gripped laundry items can attach particularly gently.

Another advantageous exemplary embodiment of the invention may provide that the contour is in the form of a groove and bead running in parallel, the contour having one groove and one bead, two grooves and one bead, one groove and two beads, two grooves and two beads or a plurality of grooves and a plurality of beads. It is provided that each gripper end cap has one more groove than it does beads or one more bead than it does grooves. However, it is also conceivable for there to be an equal number of beads and grooves. While the bead is formed in the manner of a trough, the groove represents a wave. Both the groove and the bead or the plurality of grooves and plurality of beads are formed parallel to one another on the lateral surface of the body in the manner of a continuous contour. The groove and bead are oriented perpendicularly to a vertical axis.

Furthermore, it is conceivable according to the invention that the contour extends around the entire body, namely around all four sides, that the contour extends only around three sides, namely two short sides and one long side, or that the contour extends only along one side, namely around a long side, or that the contour extends partially around the entire body. Depending on the application, it is conceivable that the contour of the gripper end cap is designed in a different way. If the contour extends at least largely around the entire body, the gripper end cap can be used very universally, without the need for a specific orientation of the gripper. The only important thing is that the two gripper end caps of a gripper are brought together. The almost circumferential contour makes it possible to ensure that no pointed or sharp edges come into contact with the laundry items and damage them.

Preferably, it is conceivable that the body has a bore, aperture or receptacle for a gripper finger, the bore, aperture or receptacle extending preferably vertically or horizontally at least partially through the body. In addition, it is conceivable that the bore, aperture or receptacle is assigned fastening means which are arranged in the body perpendicularly to the bore, aperture or receptacle, said fastening means here being in particular bores or threaded bores. For sufficient stability, the gripper finger of the gripper is pushed into the receptacle of the gripper end cap and fixed therein. This can be done using a clamping means, a latching means, a screwing means or the like. Permanent adhesive bonding is also conceivable.

For sufficient stability of the fastening of the gripper end cap to a gripper, it is conceivable according to the invention that the body has a reinforcement on one side, in which reinforcement the at least one fastening means is arranged. This reinforcement, which may have a plate-like form, is assigned to one side, in particular a long side, of the body. Due to this reinforcement of the wall, a fastening means, such as for example a screw, is provided with enough contact area to be connected to the gripper end cap with a sufficient force fit.

It is conceivable according to the invention that the body is made of a metal, in particular aluminum, or a plastic, in particular polyamide. Polyamide in particular is inexpensive and easy to process. In addition, it has sufficient mechanical stability to maintain its shape, stability and a long service life.

A further solution to the problem stated at the outset is described by the gripper as claimed in claim 10. The gripper according to the invention for laundry items has a gripper body which is fastened movably to a handling device. This handling device may, for example, be a robot arm, a gripping and lifting module or the like. At least two movable or pivotable gripper fingers are arranged on the gripper body. A gripper end cap, namely a first and a second gripper end cap, according to the features of claim 1 is fastened to each of these gripper fingers. It is conceivable that the gripper end caps are fastened detachably to the fingers. The two gripper end caps are pivotable via the gripper fingers into an open position that releases a laundry item and into a closed position that grasps a laundry item.

A particularly preferred exemplary embodiment of the invention may provide that contours of the two gripper end caps complement one another. It is conceivable that the contour of the first gripper end cap has one, two or more grooves and the contour of the second gripper end cap has two, one or more grooves and the contour of the first gripper end cap has two, one or more beads and the contour of the second gripper end cap has one, two or more beads. The gripper accordingly has two different caps having a wavy contour. These contours mesh in the closed position. Due to the special wave shape of the meshing contour, a simple and reliable clamping of the laundry item is achieved. This generates in particular friction between the surfaces of the contours, as a result of which an intense force fit can be exerted on the laundry. The increased contact area with the laundry items distributes the force acting on the laundry items, this having a particularly gentle effect on the laundry items. The shaping of the caps thus allows individual laundry items to be pulled out of the pile of laundry under a high load. According to the invention, the meshing contours and the force fit resulting therefrom are designed precisely in such a way that all the loads required for the function can be absorbed. However, overloads that damage the laundry are avoided in that the laundry item slides out of the contours in the event of excessive loads. This enables particularly reliable but at the same time gentle handling of the laundry items.

A further preferred exemplary embodiment of the invention provides that the first gripper end cap and the second gripper end cap are fastened to the gripper fingers via mounting means. This additional mounting means simplifies the mounting and the replacement or exchange of the gripping fingers. This also allows maintenance or repair to be carried out quickly and easily. These mounting means can be for example metal sheets or plates that can be easily connected both to the gripper fingers and to the gripper end caps.

Further features, advantages and details of the invention emerge from the following description of a preferred exemplary embodiment of the invention, which will be explained in more detail below with reference to the drawing, in which:

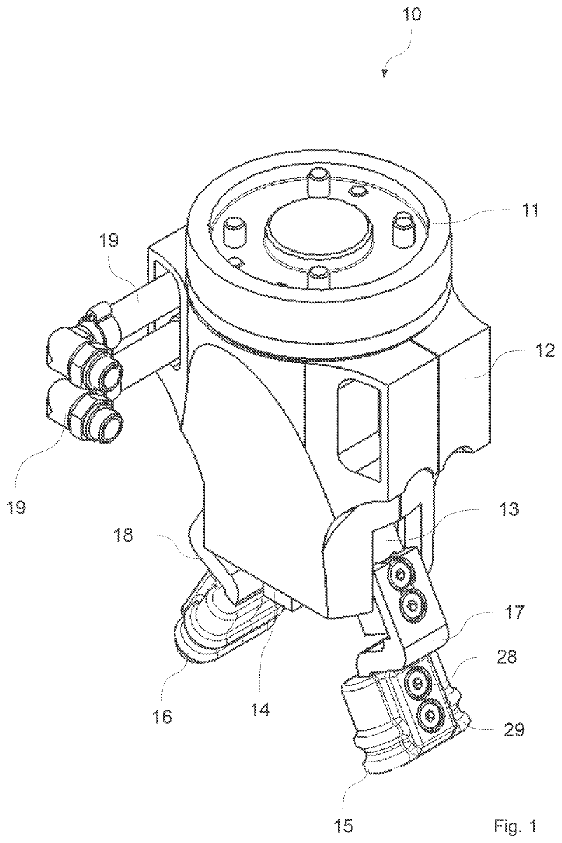

FIG. 1 shows a gripper in the open position,

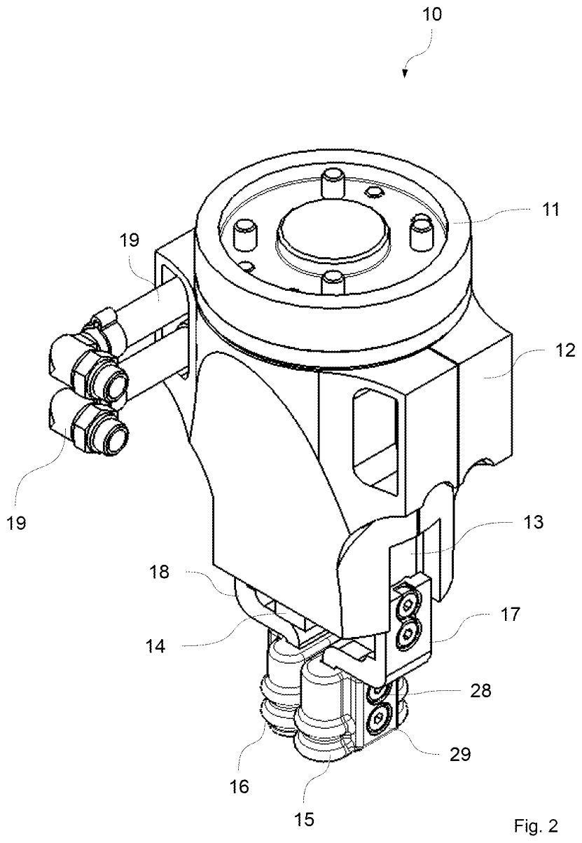

FIG. 2 shows a gripper in the closed position,

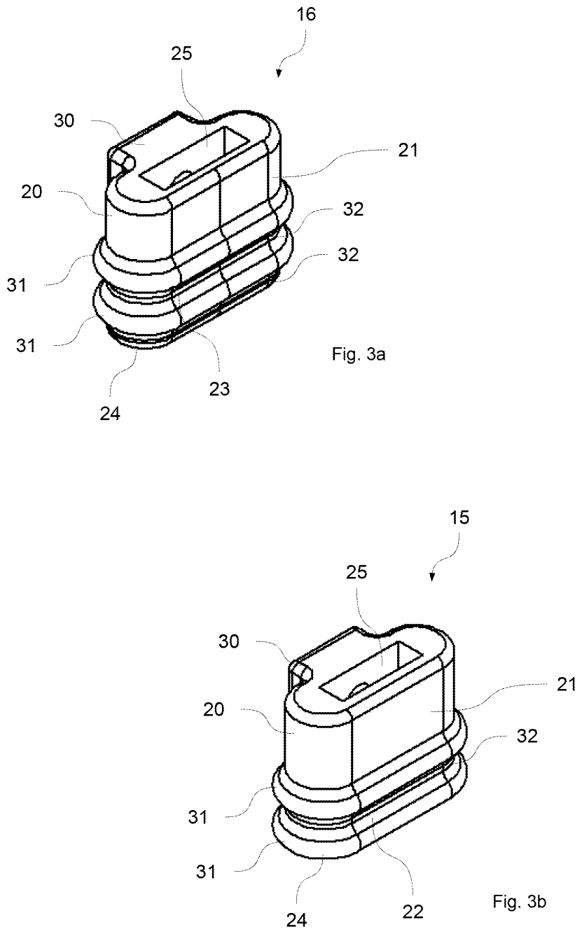

FIG. 3a shows a perspective illustration of a first gripper end cap,

FIG. 3b shows a perspective illustration of a second gripper end cap,

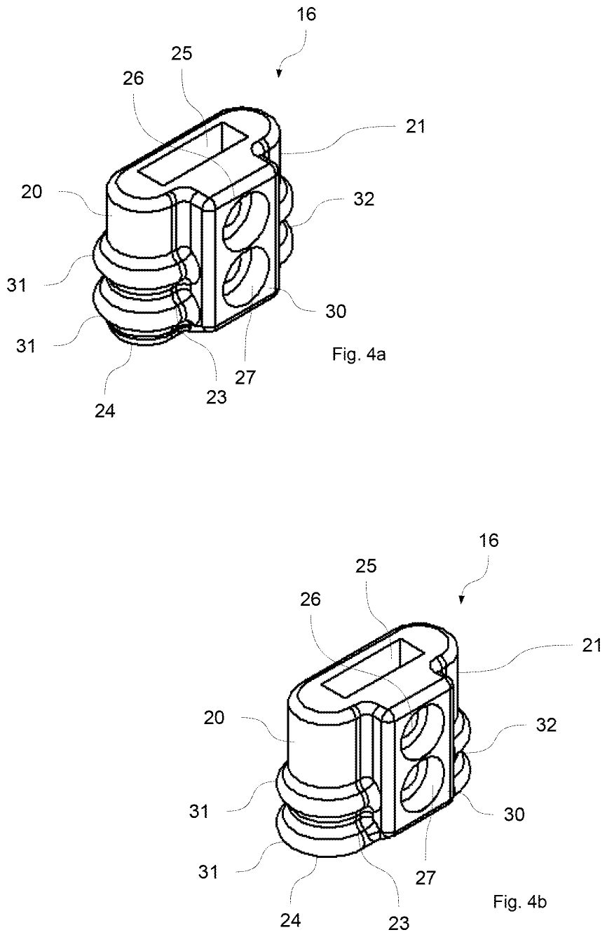

FIG. 4a shows a perspective illustration of the first gripper end cap,

FIG. 4b shows a perspective illustration of the second gripper end cap,

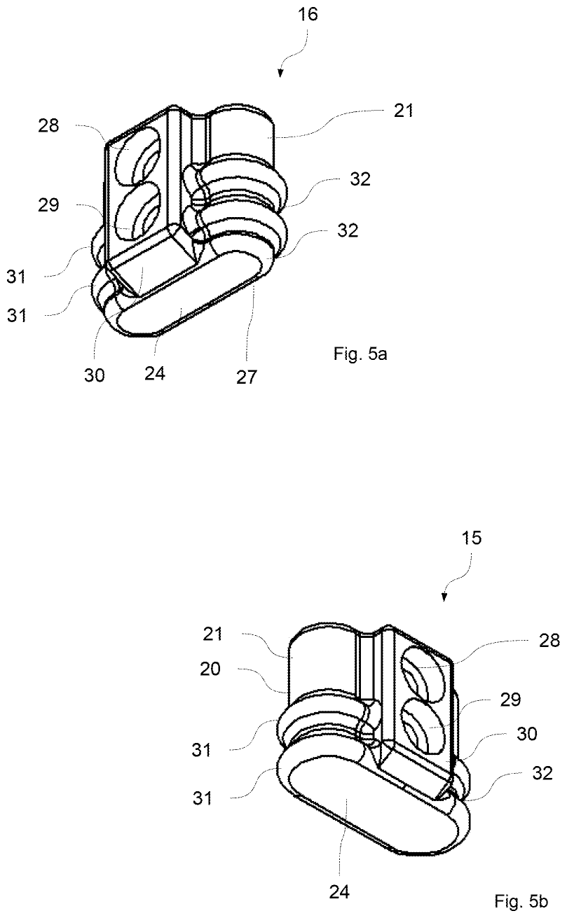

FIG. 5a shows a perspective illustration of the first gripper end cap,

FIG. 5b shows a perspective illustration of the second gripper end cap,

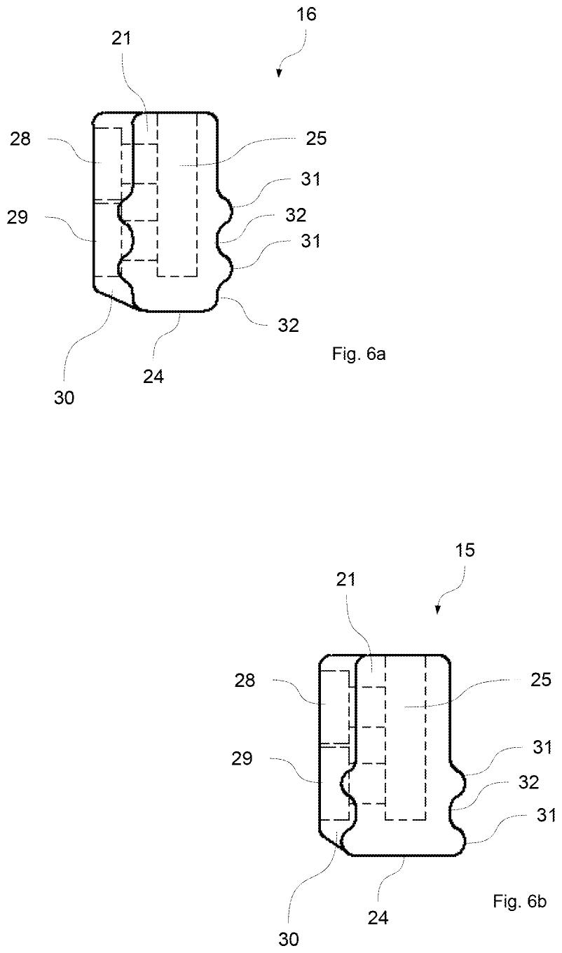

FIG. 6a shows a sectional illustration through the first gripper end cap,

FIG. 6b shows a sectional illustration through the second gripper end cap,

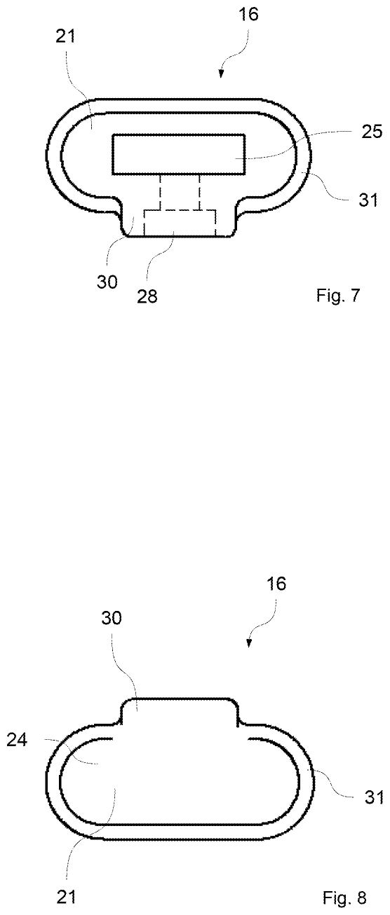

FIG. 7 shows a sectional illustration through a gripper end cap,

FIG. 8 shows a side view of a gripper end cap,

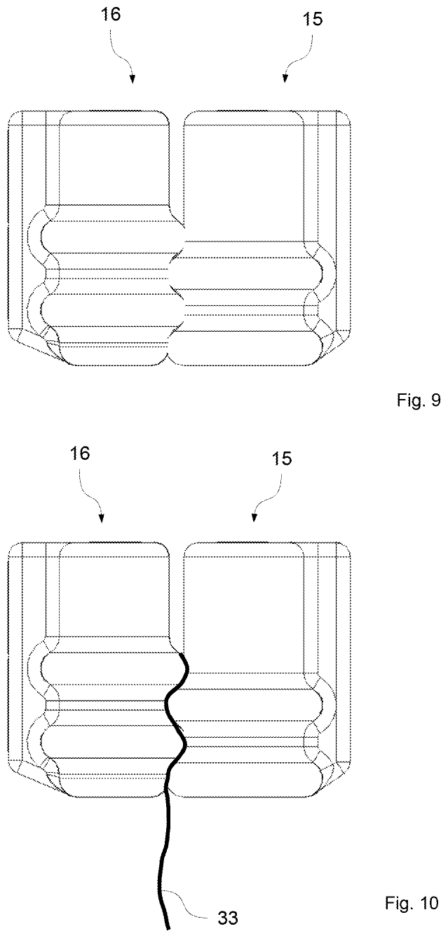

FIG. 9 shows an illustration of the gripper end caps, and

FIG. 10 shows an illustration of the gripper end caps with a gripped laundry item.

For the automatic handling of laundry items, it is provided in particular in laundries that a gripper 10 is moved up to and grasps individual laundry items. A possible exemplary embodiment of a gripper 10 of this type is illustrated in FIG. 1. For the automatic handling of the laundry items, the gripper 10 can be connected via a mounting plate 11 to a robot arm (not illustrated) or the like. This robot arm, which can equally be a delta robot or the like, allows the gripper 10, controlled by a corresponding control unit, to move up to laundry items, in particular a pile of laundry or individual laundry items. The gripper 10 allows individual laundry items to be gripped and fed to further treatment stations, such as for example a sorting station or a washing device.

The gripper 10 consists essentially of a gripper body 12, on which in the exemplary embodiment illustrated in FIG. 1 two gripper fingers 13, 14 are movably arranged at an end opposite the mounting plate 11. While these gripper fingers 13, 14 are at one end fastened movably to the gripper body 12, the other ends according to the invention each have a gripper end cap 15, 16. These gripper end caps 15, 16 can be fastened directly to the gripper fingers 13, 14. Equally, it is conceivable that the gripper end caps 15, 16 are fastened to mounting means 17, 18, which in turn are fastened to the gripper fingers 13, 14. In the exemplary embodiment of the gripper 10 illustrated in FIG. 1, the abovementioned components are screwed to one another. However, it is equally conceivable that the mentioned components are latched or clamped to one another.

The two gripper fingers 13, 14, together with the gripper end caps 15, 16, can be pivoted with respect to one another. In FIG. 1, the gripper fingers 13, 14 are pivoted outward so that the gripper end caps 15, 16 are spaced apart from one another to receive a laundry item. The gripper fingers 13, 14 are pneumatically operable in the exemplary embodiment illustrated in FIG. 1. To this end, corresponding pneumatic connections 19 are provided on the gripper body 12. By means of the control unit (not illustrated), these connections 19 are controlled in such a way that gripper fingers 13, 14 are pivoted into the corresponding position, in particular are opened or closed. Equally, it is conceivable that the gripper fingers 13, 14 are mechanically movable and the gripper body 12 to this end has a corresponding electric motor. In addition, it is conceivable that the gripper 10 is operated hydraulically.

In FIG. 2, the gripper 10 from FIG. 1 is illustrated, but in the closed position. To this end, the two gripper fingers 13, 14 with the gripper end caps 15, 16 are pivoted relative to one another in such a way that the gripper end caps 15, 16 touch one another. If, in this position, there is a laundry item between the two gripper end caps 15, 16, said laundry item can be supplied by the gripper 10 to a subsequent treatment device. Due to the inventive shape of the gripper end caps 15, 16, the laundry item can be moved in a very reliable and simple manner.

While FIG. 3a shows an exemplary embodiment of a first gripper end cap 15, a corresponding exemplary embodiment of a second gripper end cap 16 is illustrated in FIG. 3b. The two gripper end caps 15, 16 are identical apart from their contour 22, 23, i.e. the lateral surfaces 20 of the body 21. Therefore, the same reference numerals are also used for the same features of both gripper end caps 15, 16.

The body 21 of the gripper end cap 15, 16 has an oval shape in the exemplary embodiment illustrated here. This is particularly evident from FIG. 8, which represents the view of a base area 24 of the gripper end cap 15, 16, the shape of the base area 24 being identical to the cross section of the gripper end cap 15, 16 (see FIG. 7). Equally, it is conceivable that the body 21 has a rectangular, a round, an elliptical or a similarly shaped base area 24.

The body 21 has a receptacle 25 in which a gripper finger 13, 14 or a mounting means 17, 18 can be inserted. It is conceivable that the gripper finger 13, 14 or the mounting means 17, 18 is pressed or latched in the receptacle 25. In the exemplary embodiment illustrated here, it is provided that the mounting means 17, 18 are screwed to the body 21. In the exemplary embodiment of the gripper end cap 15, 16 illustrated here, the receptacle 25 has a rectangular cross section. This can be seen, for example, from FIG. 7. Ultimately, however, the receptacle 25 may also have a different shape and is substantially dependent on the shape of the gripper fingers 13, 14. However, a rectangular shape has proved to be particularly advantageous, since the force transmission between the gripper fingers 13, 14 or the mounting means 17, 18 and the body 21 is particularly large as a result of this shape or the mentioned components can be screwed together particularly efficiently. In addition, it is clear from FIGS. 6a and 6b that the receptacle 25 does not extend through the entire body 21, but rather is a blind hole. From the same figures, namely from FIGS. 6a, 6b and 7, it can be seen that the body has two bores 26, 27. These bores 26, 27 extend through the body 21, perpendicularly in relation to the receptacle 25. These bores 26, 27 are used to accommodate a screw 29 in order to screw the gripper end caps 15, 16 to the gripper fingers 13, 14 or the mounting means 17, 18. To this end, the gripper fingers 13, 14 or the mounting means 17, 18 have corresponding threads. In the exemplary embodiment illustrated here, the bores are designed in such a way that the screws 28, 29 are countersunk and do not project beyond the lateral surface 20 of the body 21, but rather form a flat surface with the lateral surface 20. Equally, it is of course also conceivable that the body 21 has only one bore or three or more. In order for it to be possible to subject the screws 28, 29 to the required force for screwing the gripper end caps 15, 16 to the mounting means 17, 18, the exemplary embodiment illustrated here provides for the body 21 to have a reinforcement 30. This reinforcement 30 is essentially a thickening of the body on the side where the bores 26, 27 are located. This can be seen, for example, from FIGS. 7 and 8.

For a reliable and gentle gripping of the laundry items, it is provided according to the invention that the contours 22, 23 of the two gripper end caps 15, 16 are different. The contours 22, 23 of the gripper end caps 15, 16 have a substantially wave-like form. This waviness is formed by beads 31, between which a groove 32 forms. These beads 31 and the groove 32 extend at least largely around the lateral surface 20 of the body 21. From FIGS. 7, 8 it can be seen that the beads 31 and the groove 32 extend around the reinforcement 30. Equally, however, it is also conceivable that the beads 31 and the groove 32 extend around the entire lateral surface 20. In the exemplary embodiment illustrated in FIG. 3a, it can be seen that two beads 31 extend around the body 21, while a groove 32 is formed between the two beads 31. Since the lower bead 31 is spaced apart from the base area 24, a groove 32 is also formed between this base area 24 and the lower bead 31. This is particularly clear from the section through the first gripper end cap 15 illustrated in FIG. 6a.

In a manner that complements the first gripper end cap 15 illustrated in FIG. 3a, in the case of the second gripper end cap 16 illustrated in FIG. 3b the two beads 31 are offset downward, namely toward the base area 24. This is particularly clear from FIG. 6b. Here, too, a groove 32 forms between the two beads 31. Since a bead 31 directly adjoins the base area 24 in the exemplary embodiment according to FIG. 3b, no further groove is formed here.

The beads 31 and the grooves 32 of the first and second gripper end caps 15, 16 are offset relative to one another on the lateral surface 20 in such a way that they mesh in the closed position. This is illustrated, for example, in FIG. 2, but above all in FIGS. 9 and 10. However, the exemplary embodiments illustrated here are not designed in such a way that the beads 31 and grooves 32 of the various end caps 15, 16 interlock. If a laundry item 33 is located between the two gripper end caps 15, 16 or between the two contours 22, 23 when closing or pivoting the gripper fingers 13, 14, said laundry item is clamped between the beads 31 and grooves 32. The contact area between the laundry item 33 and the end caps 15, 16 is dimensioned such that the force acting on the laundry item 33 is distributed over a relatively large area, which has a particularly gentle effect on the laundry item 33. On the other hand, the force transmitted to the laundry item 33 is sufficiently large to reliably pull the laundry item 33 out of, for example, a pile of laundry and pass it on for further treatment. In particular, the shape of the bead 31 and of the groove 32 has the effect that the laundry item 33 is not only clamped, but rather friction is generated between the gripper end caps 15, 16 and the laundry item 33, by means of which friction a particularly efficient force transmission is possible.

It is very clear in particular from FIGS. 3 to 5 that the body 21 has almost exclusively round shapes and no pointed edges or corners that could damage the laundry item 33. Even in the event that a laundry item 33 unintentionally snags on the gripper end caps 15, 16, irreversible damage can be prevented by this round shaping.

### List of Reference Signs:

10 gripper
11 mounting plate
12 gripper body
13 gripper finger
14 gripper finger
15 first gripper end cap
16 second gripper end cap
17 mounting means
18 mounting means
19 pneumatic connection
20 lateral surface
21 body
22 contour
23 contour
24 base area
25 receptacle
26 bore
27 bore
28 screw
29 screw
30 reinforcement
31 bead
32 groove
33 laundry item

1. A gripper end cap for a gripper for gripping a laundry item, consisting of a body having a wave-like contour which extends at least partly around the body.

2. The gripper end cap for a gripper as claimed in claim 1, wherein the body has a rectangular, polygonal, rounded, oval or elliptical base area and a rectangular, polygonal, rounded, oval or elliptical cross section.

3. The gripper end cap for a gripper as claimed in claim 1, wherein the wave-like contour extends at least partly around a lateral surface of the body, the contour being formed from semicircles and partial circles pointing away from the body and protruding into the body.

4. The gripper end cap for a gripper as claimed in claim 1, wherein the contour is in the form of a groove and bead running in parallel, the contour having one groove and one bead, two grooves and one bead, one groove and two beads, two grooves and two beads or a plurality of grooves and a plurality of beads.

5. The gripper end cap for a gripper as claimed in claim 1, wherein the contour extends around the entire body, namely around all four sides, the contour extends only around three sides, namely two short sides and one long side, or the contour extends only along one side, namely around a long side, or the contour extends partially around the entire body.

6. The gripper end cap for a gripper as claimed in claim 1, wherein the body has a bore, aperture or receptacle for a gripper finger, the bore, aperture or receptacle extending preferably vertically or horizontally at least partially through the body.

7. The gripper end cap for a gripper as claimed in claim 6, wherein the bore, aperture or receptacle is assigned fastening means which are arranged in the body perpendicularly to the bore, aperture or receptacle, said fastening means here being in particular bores or threaded bores.

8. The gripper end cap for a gripper as claimed in claim 7, wherein the body has a reinforcement on one side, in which reinforcement the at least one fastening means is arranged.

9. The gripper end cap for a gripper as claimed in claim 1, wherein the body is made of aluminum, or polyamide.

10. A gripper for laundry items, comprising a gripper body which is fastenable movably to a handling device and comprising at least two gripper fingers arranged movably on the gripper body, with a gripper end cap, namely a first gripper end cap and a second gripper end cap, as claimed in claim 1 being fastened preferably detachably to each of the two gripper fingers, said gripper end caps being pivotable via the gripper fingers into an open position that releases a laundry item and into a closed position that grasps a laundry item.

11. The gripper as claimed in claim 10, wherein contours of the two gripper end caps complement one another.

12. The gripper as claimed in claim 11, wherein the contour of the first gripper end cap has one, two or more grooves and the contour of the second gripper end cap has two, one or more grooves and the contour of the first gripper end cap has two, one or more beads and the contour of the second gripper end cap has one, two or more beads.

13. The gripper as claimed in claim 10, wherein the first gripper end cap and the second gripper end cap are fastened to the gripper fingers with their contours facing one another, so that the contours mesh in the closed position.

14. The gripper as claimed in claim 10, wherein the first gripper end cap and the second gripper end cap are fastened to the gripper fingers via mounting means.
